(19) United States
(12) Patent Application Publication
(10) Pub. No.: US 2002/0147849 A1
(43) Pub. Date: Oct. 10, 2002

(54) Delta encoding using canonical reference files

(76) Inventors: Chung-Kei Wong, Mountain View, CA (US); Gary Nutt, Boulder, CO (US); Vikas Jha, Hillsborough, CA (US); R. Ashok Sudarsanam, Newark, CA (US); Spyro Papademetriou, Arlington, VA (US); Anshu Aggarwal, Foster City, CA (US)

Correspondence Address: HICKMAN PALERMO TRUONG & BECKER, LLP, 1600 Willow Street, San Jose, CA, 95125-5106, US

(21) Appl. No.: 10/117,006

(22) Filed: Apr. 4, 2002

Related U.S. Application Data
(60) Provisional application No. 60/282,303, filed on Apr. 5, 2001.

(51) Int. Cl. G06F 15/16; G06F 15/167

(52) U.S. Cl. 709/246; 709/213; 709/203

(57) ABSTRACT

Systems and methods are provided for implementing delta encoding for distribution of content. In one aspect, a canonical reference file that is common to a server and to each client to which the server distributes content, and which represents a portion of particular content, is generated and transmitted to the associated clients. A delta file, which represents the difference between the current state of the content and the canonical reference file, is transmitted to the requesting client so that it can be applied to the canonical reference file to construct the current state of the content. A client can receive the canonical reference file during a period in which the current state of the content differs from the reference file. Furthermore, the canonical reference file can be transmitted during a period in which the current state of the content changes.

### CROSS REFERENCE TO RELATED APPLICATION

This application claims priority from U.S. Provisional Patent Application No. 60/282,303 filed Apr. 5, 2001, entitled “Delta Encoding Using Canonical Base Files” (Atty. Docket 50269-0522), which is hereby incorporated by reference herein in its entirety for all purposes.

### FIELD OF THE INVENTION

The present invention relates generally to content distribution and, more specifically, to techniques for implementing delta encoding using a canonical base representation.

### BACKGROUND OF THE INVENTION

Delta encoding is a technique for reducing the amount of data that has to be transmitted, when content is modified, between sites that store copies of the content. In implementing delta encoding, a server and associated clients keep common base representations of content. When the server receives updated content from an origin server, it computes the difference between its stored (or base) representations and the updated representation. These differences are called the delta. The server then transmits only the relevant delta to a requesting client, where it is decoded and reconciled with its base representation to form the updated representation of the requested content. In the context of the Internet or other communication networks, delta encoding reduces the bandwidth requirement between a server and a client machine, such as a computer running a web browser, by reducing the amount of data transmitted between the server and the client due to transmission of the delta representation instead of the complete content representation. In the context of source code control systems, data storage requirements are reduced though implementation of delta encoding by archiving a base representation and deltas rather than archiving complete versions of the code each time it is modified.

Delta encoding is implemented in many contexts. For example, Internet web content delivery, MPEG encoding, source code tracking systems, distributed shared memory systems, and incremental UNIX file dumps all typically use some implementation of the general concept of delta encoding. For web content, delta encoding is currently described in IETF RFC 3229, entitled “Delta encoding in HTTP” and dated January 2002, which is incorporated by reference herein in its entirety for all purposes.

Content caching technology (also known as content distribution and content delivery), in the context of the Internet, originated to improve the performance of web sites by pushing content (primarily graphics and embedded images at first) out to a network of edge caching servers. Caching technology reduces transmission times to end users (content requesters) by delivering that content from a server geographically closer to the end user than the origin server, thus reducing router hops and overall latency. Hence, implementation of caching technology by Internet Service Providers (ISP) provides benefits due to faster delivery of content to customers, and thus, more satisfied customers. In addition, caching content at the network edge reduces bandwidth consumption by eliminating the need to retrieve the content from an origin server by the requesting end user. Thus, the content can be transmitted from a local edge caching server to the end user, thereby reducing the bandwidth required of interstate backbone networks, which ISPs typically pay for directly, or by bypassing the backbone networks altogether.

Although caching started with static content, there is also a demand for the caching of dynamic content, e.g., frequently changing sports scores or stock quotes. Furthermore, customers are likely to demand caching support for network-based application and transaction processing, as well as distributed web services. Still further, the demand for content distribution technologies has reached enterprises, which could benefit from moving files, data, source code, etc. to the edge of their enterprise networks closer to their users, and from reducing storage requirements for multiple versions of a same or similar resource.

In caching implementations, a proxy server acts as an intermediary between a user at a workstation and the Internet or other network and is often implemented with, or as, a cache server. The proxy and cache functionality may be separate server programs or may be part of integrated software suites. When a proxy server receives a request for content or for a service, it typically first looks in its local cache of previously downloaded content. If it finds the requested content, it returns it to the user without needing to forward the request to the Internet or other network. If the content is not in the cache, the proxy server, acting as a client on behalf of the user, uses one of its own IP addresses to request the page from the origin server out on the Internet or other network. When the page is returned, the proxy server relates it to the original request and forwards it on to the user, virtually transparently to the user. An advantage of a proxy server is that its cache can serve many users. If one or more content (e.g., a web page) are frequently requested, these are likely to be in the proxy's cache, which will improve user response time.

Shortcomings identified with respect to prior approaches to delta encoding include: (a) the proxy server (or other “source” server) must keep a copy of each base representation that is used by each of its clients, placing extraordinary storage requirements on the server because each client could potentially use a different base representation generated when they first request the content; (b) the proxy server must generate multiple delta files, that is, potentially one delta file for each and every base representation version; and (c) when a particular base representation ceases to be used by any client, the server will attempt to continue to save its copy even though it will never be used again.

For example, with respect to Internet content distribution, delta encoding previously could not be successfully used for “search” pages because the returned page is different for each unique search requested. Furthermore, for the same reasons, delta encoding previously could not be used for personalized content, for example, a personalized web site generating and displaying current information about a person's stock portfolio. Hence, delta encoding has major shortcomings with respect to dynamic content, which is content that is generated by execution of a program at the time of the request. In summary, prior approaches to delta encoding, implemented in various contexts, have failed due to data explosion issues at the server. In particular with respect to implementation with caching technology, delta encoding has not previously been successfully implemented for the same reasons.

Based on the foregoing, it is clearly desirable to provide a mechanism for implementing delta encoding in caching environments, which does not cause significant data explosion. Furthermore, it is desirable to provide a mechanism for implementing delta encoding for dynamic content that is generated in response to a request. Still further, it is desirable to provide a mechanism for implementing delta encoding that is applicable to multiple types of resources.

### SUMMARY OF THE INVENTION

Mechanisms are provided for efficiently implementing delta encoding across multiple contexts and for multiple resource types. Examples of implementations include, without limitation, caching of dynamic resources across the Internet, storage and delivery of popular application data files within an enterprise network, and storage and delivery of source code within a code control system.

According to one aspect, a canonical base representation, or reference file, is generated for a portion of content wherein the canonical reference file is common to a server and to each client to which the server provides content. A client can receive the canonical reference file during a period in which the current state of the content differs from the reference file. Furthermore, the canonical reference file can be transmitted during a period in which the current state of the content changes. When a client that does not currently have the canonical reference file requests the content, the client is sent (1) the canonical reference file and (2) a delta file that represents the difference between the current state of the content and the canonical reference file. When a client that does currently have the canonical reference file requests the content, the client is sent the delta file. The client applies the delta file to the reference file to generate the current state of the requested content, but continues to maintain a copy of the reference file. In one embodiment, the reference file represents static content whereas the delta file represents dynamic content. In one embodiment, the current state of the content is retrieved from a cache.

Additional embodiments are directed to multi-server environments, wherein the canonical reference file is common to the multiple servers and to each of the clients of each of the multiple servers. Related embodiments include generating the canonical reference file by coalescing reference files from the multiple servers, and transmitting the canonical reference to each of the multiple servers.

Various implementations of the techniques described are embodied in methods, systems, apparatus, and in computer-readable media.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating a process for implementing delta encoding for distribution of content, according to an embodiment of the invention;

FIG. 2A is a block diagram illustrating a simple client-server computing environment, in which an embodiment of the invention may be implemented;

FIG. 2B is a block diagram illustrating a client-server computing environment, on which an embodiment of the invention may be implemented; and

FIG. 3 is a block diagram illustrating a computer system upon which an embodiment of the invention may be implemented.

### DETAILED DESCRIPTION

A method and system are described for content distribution using delta encoding using a canonical base representation of the content. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Delta Encoding Using Canonical Reference Files

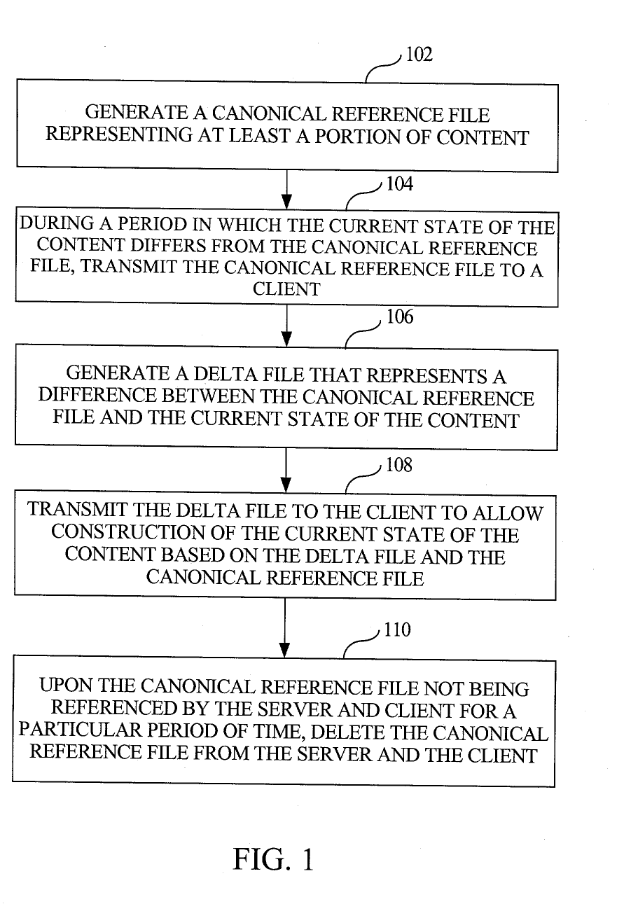

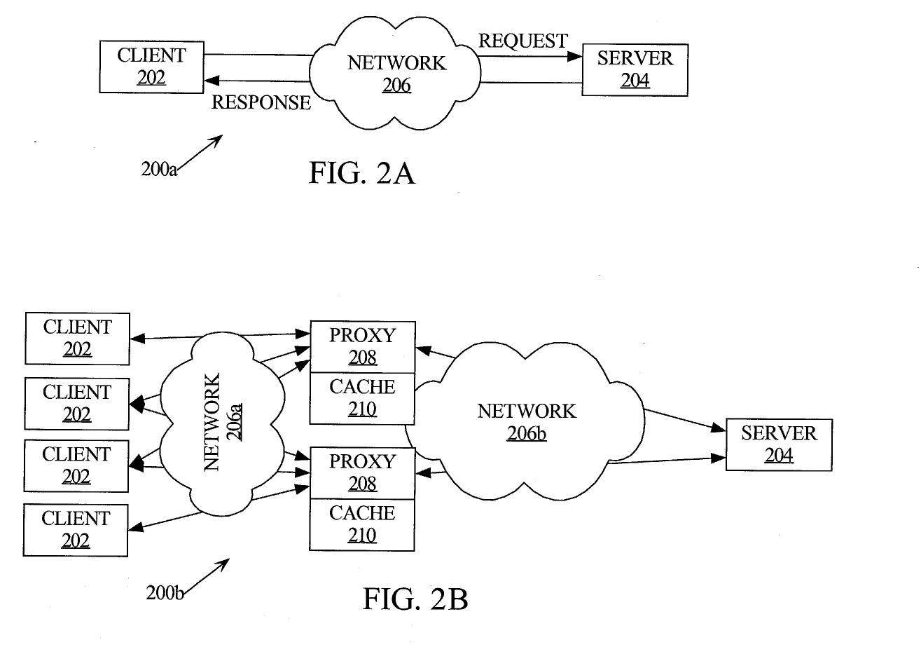

FIG. 1 is a flowchart illustrating a process for implementing delta encoding for distribution of content, according to an embodiment of the invention. The process is described in the context of a client-server computing environment, whereby a server provides content to an associated client in response to a client request (described in more detail in reference to FIG. 2A). At step 102, a canonical reference file (referred to herein also as “reference file”) is generated that represents at least a portion of some content. The invention is independent of the type of content, and thus, distribution of all types of content (sometimes referred to as resources) from one computer to another computer is within the scope of the invention. For example, without limitation, the content may include an HTML file representing a web page, source code, audio and/or video media, distributed applications or web services, and business/office application files (e.g., Microsoft Word, PowerPoint, and Excel files).

The term canon is used to refer to a commonly accepted principle, rule, standard, or norm. Hence, a canonical reference (or base) file refers to one that is common to all parties adhering to the canon. In other words, a canonical reference file is a common reference that all parties accept as being the principle, or authoritative, representation of a particular portion of the content. Therein lies a key advantage of the invention, that is, that the canonical reference file, for a particular resource, is common to a server and to each client (such as server 204 and client 202 of FIGS. 2A and 2B) to which the server distributes the resource, or content. Hence, a single reference file is canonical for the server and each of its associated clients, so only a single reference file need be stored in the server for a particular resource. In contrast, prior approaches to delta encoding in a client-server environment require the server to maintain independent reference files for multiple clients since different clients first request a particular resource at different times, thus requiring a different “snapshot” of the resource (i.e., a reference file) at each of those different times. Appreciate that at least significant storage and computing resources are conserved through practice of the invention, in comparison to prior approaches described above.

The particular portion of the content represented, the manner and frequency in which the particular portion is determined, and the manner in which the particular portion is represented, may vary from implementation to implementation.

A variety of techniques may be use to generate a canonical reference file (step 102 of FIG. 1). According to one embodiment, directed to a multi-server environment (as illustrated in FIG. 2B), a canonical reference file is generated by coalescing reference files from the multiple servers. Thus, reliance on statistical convergence to derive a common base file from separate reference files derived by each of multiple servers is not necessary. Discrete processes for coalescing reference files from multiple servers to generate a canonical reference file are beyond the scope of the present invention, and thus are not described herein. According to one embodiment, the reference file is generated at one of the multiple servers and then transmitted to the other associated servers.

### Canonical Reference File Generation

Various events may trigger the generation (or re-generation) of a canonical reference file. According to one embodiment, generation of the reference file is initiated upon a predefined condition being met (i.e., becoming true). Examples of conditions that may be used to trigger the generation of a reference file for particular content include, without limitation (1) the expiration of a period of time since the last generation of a reference file for that particular content, (2) receipt of a manual command to generate a reference file for that particular content, (3) detecting that a delta file (described below) size threshold is reached or exceeded, (4) detecting that the amount of requests for said particular content reaches or exceeds a “request threshold” with respect to the particular content, and/or (5) detecting that the load on a particular server reaches or exceeds a certain threshold.

For example, condition (1) may be implemented to occasionally reset the content baseline for particular content, to ensure that the size of the associated delta files is consistently minimized (or pruned), thus providing consistent and ongoing benefits to the network operations. For example, condition (2) may be implemented for similar reasons as presented for condition (1). For another example, condition (3) may be met when the quantity and nature of the changes made to a particular content, since generation of the previous reference file, result in the size of a delta file (associated with the particular content) approaching or exceeding the size of the canonical reference file or some other defined size threshold. For another example, condition (4) may be met when the number of requests for the content exceeds a defined threshold since generation of the previous reference file, thus suggesting that the content is popular and that network operations would benefit from a new reference file and therefore from a resulting reduction in the size of an associated delta file that is transmitted through the network. The preceding examples are presented for purposes of explanation and are not intended to limit the scope of the invention to implementation of any of these examples.

According to one embodiment, the canonical reference file represents the static portion of the content. As an example, in the context of a frequently changing web page, the reference file may include the information representing the page format, such as frames, tabs, headers, logos, input entry fields, legal notices, etc. In the context of an infrequently changing web page, the reference file may include a representation of the formatting information plus additional content information, such as text, images, links, etc. In the context of a Word document, the reference file may include a representation of all of the underlying formatting commands, essentially everything in the .doc except the actual text.

### Canonical Reference File Transmission

Returning to FIG. 1, at step 104, during a period in which the current state of the content differs from the canonical reference file, the canonical reference file is transmitted to one or more clients to which the server distributes content. For the purpose of explanation, embodiments shall be described in which, for a particular set of content, the same canonical reference file is transmitted to all clients that use that particular set of content. However, benefits may still be realized even if only a subset of those clients share the same canonical reference file. For example, a server may provide a particular set of content to five clients, but one of those clients may be very rarely used. Under these circumstances, it may be desirable to provide the canonical file to the four frequently used clients, but to simply send content to the fifth client, without using any reference file or delta file, on an as-requested basis. Similarly, benefits may be realized if, for the same set of content, the server maintains one reference file for one set of clients, and another reference file for another set of clients. However, benefits diminish if the number of distinct reference files for the same content begins to approach the number of clients to which the server provides the content.

The techniques described herein may be applied to any client-server environment. For example without limitation, the client-server environment may be in the context of the Internet where the server distributes web pages to clients, or in the context of an enterprise organization wherein the server distributes source code or office application files to clients. In a multi-server environment, at step 104 the reference file is transmitted to one or more of the clients associated with each of the servers. The reference file is stored locally at the client, typically in local cache, for future retrieval and application.

In one embodiment, transmission of the reference file to the client is in response to a first request from the particular client for the particular content. Thus, in contrast to prior systems, a first request for particular content is not always answered with an up-to-date or current version of the particular content. Rather, it is answered with the current reference file for the particular content, and a delta file with which the client may construct the current version of the particular content.

As with reference file generation, various events may trigger the transmission of a canonical reference file to a client. According to one embodiment, transmission of the reference file is initiated upon a predefined condition being met. Examples of conditions that may be used to trigger the transmission to a client of a reference file for particular content include, without limitation (1) the expiration of a period of time since the last transmission of a reference file for that particular content, (2) receipt of a manual command to transmit a reference file for that particular content, (3) detecting that a delta file (described below) size threshold is reached or exceeded, (4) detecting that the amount of requests for said particular content reaches or exceeds a “request threshold” with respect to the particular content, and/or (5) detecting that the load on a particular server reaches or exceeds a certain threshold.

For example, condition (1) may be met when the time between generation of a reference file for particular content meets or exceeds a defined period of time, thus triggering a generation of new reference file version, which could trigger transmission of the new reference file version to a client that has previously requested the particular content. Alternatively, condition (1) may be met when a client has not requested the particular content for a period of time, at which time the reference file may be “pushed” to the client, without a specific request, in anticipation of future requests for the particular content. For example, condition (2) may be implemented to occasionally reset the content baseline at clients for particular content, to ensure that the size of the associated delta files is consistently minimized (or pruned), thus providing consistent and ongoing benefits to the network operations. Example scenarios and associated rationale presented above with respect to conditions (3) through (5) for reference file conditional generation are also applicable to reference file conditional transmission. Again, the preceding examples are presented for purposes of explanation and are not intended to limit the scope of the invention to implementation of any of these examples.

### Delta File Generation and Transmission

At step 106, a delta file (or simply “delta”) is generated. A delta file for particular content represents the difference between a reference file for the particular content and the current state of the particular content. The current state of the content is the state of the content at an origin server, where the original content resides. Through application of delta encoding, the client can apply the delta file to the canonical reference file to generate, or derive, the current state of the content. At step 108, the delta file is transmitted to a client to allow construction of the current state of the content based on the delta file and the canonical reference file. The transmission of the delta file may occur in response to the client's first request (in which case it is accompanied by the reference file), or in response to a subsequent request (in which case it would only be accompanied by a reference file if a new reference file has been generated for the particular content). Furthermore, the delta file may be transmitted during a period in which the current state of the content changes.

In an embodiment where all relevant servers and clients have access to the same canonical reference file for a particular content, not only does the inventive process reduce the amount of computing resources for storing and maintaining reference files at the servers, but it also reduces the amount of computing resources required for generating, maintaining, and storing delta files at the servers. That is, since all relevant clients have received the same reference file for the particular content and are thus operating relative to the same baseline information, it is more likely that multiple clients would require the same delta file based on the current state of the content at the time of respective client requests for the particular content. Any clients working from the same reference file for the particular content, that request the content while it is in a specific current state, will receive the same delta file relative to that particular content. Hence, the servers maintain and store fewer delta files than in prior approaches. Of course, successive clients that request the content at different “current” states of the content (i.e., at different times before and after the content is changed) will be transmitted different delta files representing the different states. According to one embodiment, the delta files are not stored at the server, but generated in response to content requests, transmitted to the requesting client, and purged.

Various techniques may be used for determining content delta and generating a delta file therefrom. The invention is not limited to any particular processes for determining content delta or for generating a delta file.

According to one embodiment, the current state of particular content, which is used to generate the associated delta file, is retrieved from a cache of content previously retrieved from an origin or other server. Furthermore, the cache may be operational through the functionality of a cache server, which may be coexistent with a proxy server, as illustrated in FIG. 2B.

According to one embodiment, in which the canonical reference file represents the static portion of the content, the delta file represents the dynamic portion of the same content. As an example, in the context of a web page, the delta file includes a representation of the information being generated in real-time in response to a user request. In the context of a Word document, for example, the delta file may include a representation of the actual text and formatting that has been added or modified relative to the reference file.

According to one embodiment, the delta file is compressed prior to the step of transmitting the delta file to a client (step 106 of FIG. 1). The invention is independent of any particular compression algorithm or technique, thus any standard or proprietary compression techniques or algorithms can be used within the scope of the invention. Furthermore, according to one embodiment, the compression techniques utilized with respect to the delta file transmissions are streaming technology techniques, which allow the content to be displayed as it arrives without having to wait for the entire content to be received before displaying the content.

Referring again to FIG. 1, according to one embodiment, at an optional step 110, the canonical reference file is deleted from the server and from the associated clients upon the reference file not being referenced by the server or associated clients for a particular period of time. Hence, reference files representing base content that are no longer used by the server and clients do not unnecessarily use or waste storage space.

### Operating Environments

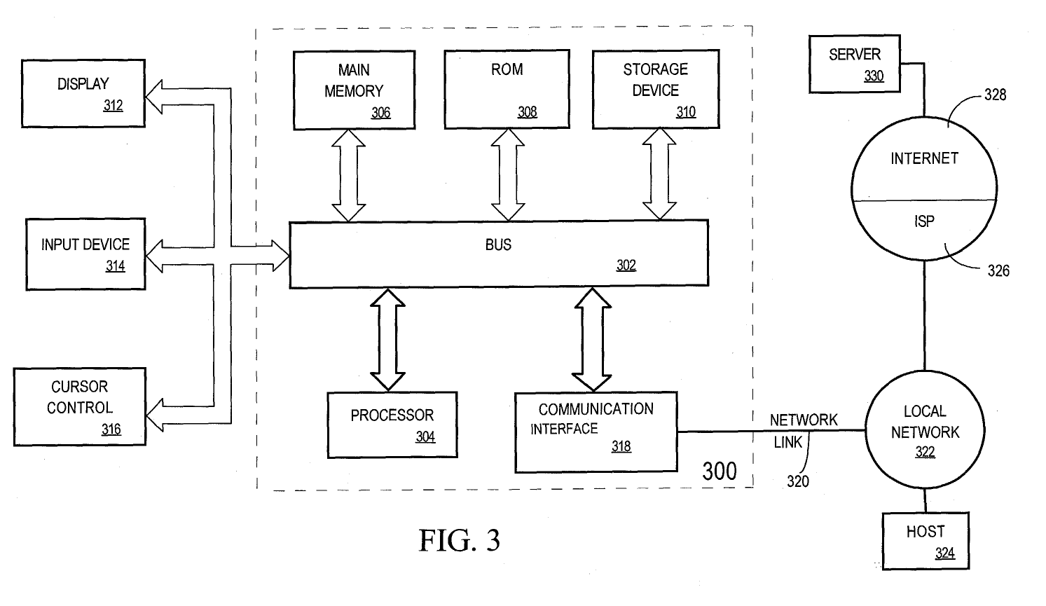

FIG. 2A is a block diagram illustrating a simple client-server computing environment, in which an embodiment of the invention may be implemented. System 200a comprises a client 202 and a server 204 that are communicatively connected through a network 206. Generally, the client 202 and server 204 are typically a combination of computer hardware and software that provide the relevant functionality and processes for performing a computing or other task. Operationally, the client 202 requests content from server 204 by submitting a request that is transmitted through the network 206. In turn, the server 204 responds by transmitting the requested content to the client 202 through the network 206. The client 202 is typically a computing resource, such as the computer system illustrated in FIG. 3, running some client software application. For example without limitation, the client 202 may be running a web browser or an operating system that supports networked computing and data storage. The server 204 includes, for example without limitation, a web server that is responsible for “serving” or delivering web pages to client web browsers, or an enterprise server used for storing and delivering various types of content such as source code, text documents, presentation documents, spreadsheet documents, audio/video media, etc., within an enterprise environment. The network 206 can include, for example without limitation, a WAN such as the Internet, or a LAN using Ethernet or other technology, within an enterprise organization.

FIG. 2B is a block diagram illustrating a client-server computing environment, in which an embodiment of the invention may be implemented. System 200b comprises multiple clients 202, a server 204, and multiple proxies 208, communicatively connected through one or more networks referred to separately as network 206a and network 206b. Note that networks 206a and 206b may be a single network, such as an enterprise network, or may be multiple networks, such as the Internet and an enterprise network or some other subnetwork. The proxy 208 (or “proxy server”) acts as an intermediary between the client 202 and the server 204, which is typically an origin server. A proxy is often associated with a gateway that separates networks, such as network 206a and network 206b. In caching implementations, when a proxy such as proxy 208 receives a request for content or for a service, it typically first looks in its local cache of previously downloaded content. If it finds the requested content, it returns it to the requesting client, such as client 202, without needing to forward the request through the network such as the Internet, or network 206b. If the page is not in the cache, the proxy requests the content from an origin or other server, such as server 204, through the network.

In one embodiment, a system for implementing delta encoding for distribution of content includes at least one server, such as server 204 and/or proxy 208, and one or more clients 202, each configured with computer programs for performing respective portions of a delta encoding process, as described above. In one embodiment, the system is configured with server-side delta encoding software and pre-installed client-side delta decoding software. The term pre-installed means that the software is installed on the client machine prior to reception of the delta file, instead of being “installed” virtually concurrently with reception of the delta file. In alternative embodiments, the delta decoding software is transmitted as an applet, script program, or similar software application that is transmitted over a carrier wave substantially concurrent with the delta file.

In an embodiment that uses pre-installed client-side delta decoding software, the decoding software may even be installed on the client machine prior to reception of the canonical reference file. This embodiment overcomes limitations of prior approaches, in which the decoding software is transmitted via an applet or similar program along with the delta file, whereby such a transmission is subject to significant latency due to the size (and thus bandwidth required) of the decoding software. Often, the size of the decoding software, coupled with the delta file, exceeds the size of the complete requested content.

According to one embodiment, a system for implementing delta encoding for distribution of content as described above in reference to FIG. 1, comprises at least one server, such as proxy 208 or server 204, configured to generate the canonical reference file representing a portion of the content (e.g., step 102 of FIG. 1), and to generate the delta file representing the difference between the reference file and the current state of the requested content. Note again that the canonical reference file is common to at least the server 204 or proxy 208 and to each of one or more clients, such as client 202, to which the server 204 or proxy 208 distributes content. Furthermore, the server 204 or proxy 208 is configured to transmit the reference file to at least one associated client 202 to which it distributes content (e.g., step 104 of FIG. 1). Though not so limited, the server 204 or proxy 208 typically transmits the reference file to a client 202 upon a first request for the associated content from the client 202. Still further, the server 204 or proxy 208 is configured to transmit the delta file for the requested content to a particular client 202, often upon a request for the content from the particular client 202 (e.g., step 106 of FIG. 1). Note that, in the case of a first request for a particular content, transmission of the delta file can occur virtually concurrently with transmission of the reference file. Thus, the current state of the content can be reconstructed at the client 202 from the reference and delta files. For content re-requests, (i.e., requests for particular content other than the first request for the particular content, from a particular client), the delta file is transmitted without the reference file because the particular client has previously received the associated reference file.

According to one embodiment, the system further comprises a client program configured on at least one client computer, such as client 202, to receive the canonical reference file and the delta file from the server 204 or proxy 208. In addition, the client program is configured to apply the delta file to the reference file to generate the current state of the requested content. As the invention is not limited to use of any particular delta encoding technique or algorithm, consequently, application of the delta file with the reference file can utilize any delta encoding/decoding techniques known in the art. Once the delta and reference files are applied to generate the requested content, the requested content can be displayed on a monitor communicatively coupled to the client computer, through conventional means such as a web browser, word-processing application, or other viewing/displaying mechanism.

In one embodiment, directed to a multi-server (or multi-proxy) environment (as illustrated in FIG. 2B), generation of the canonical reference file, common to the multiple proxies 208 and their associated clients 202, comprises coalescing reference files from the multiple proxies 208. The reference file is transmitted to clients 202 associated with each of the multiple proxies 208. In one related embodiment, the canonical reference file generated by coalescing reference files from multiple proxies 208 is transmitted by one of the servers to one or more of the other multiple proxies 208, so that each proxy 208 has local access to the common canonical reference file.

According to one embodiment, in a multi-server environment in which multiple servers, such as proxies 208, are responsible for serving common content, a client 202 (for example without limitation, through the client software or through a web browser) can switch among the servers 208 to provide, for example, fault tolerance and load balancing.

According to one embodiment, the system 200b is configured with a cache server 210 configured to store content retrieved through a network from another server, such as origin server 204, wherein the proxy 208 can retrieve the current state of the requested content from the cache server 210. Hence, direct communication between the proxy 208 and the origin server 204 is not required.

Appreciate that the invention can provide benefits in multiple types of operating installations. For example without limitation, an ISP may use proxy servers (e.g., proxy 208) configured with cache servers (e.g., cache server 210), installed at the “edge” of the Internet (i.e., generally, near the interface of the ISP's subnetwork(s) and the Internet), which perform the processes described herein. An installation of this type can reduce latency to the ISP's customers, consequently providing faster access to content, as well as reduce the amount of backbone traffic required to serve their customers, thus providing cost reductions.

For another example without limitation, a content host (such as, for example without limitation, an origin server or a content distribution network (CDN)), which typically host content from multiple customers on multiple independent servers, may install a large capacity cache server to perform the processes described herein, whereby the host acts as the server and ISPs act as the clients. An installation of this type can help reduce the size of the host's content servers on which the content resides, by utilizing the functionality of the present invention in conjunction with a cache server. Furthermore, an installation of this type helps the host optimize the network links between ISPs and the host, resulting from the reduced bandwidth required to transmit the delta content instead of the complete content.

These example are not intended to be inclusive of all possible installations that might benefit from the present invention, but are presented for purposes of example. As described above, other installations in various other contexts would also provide advantages over prior approaches.

### Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, or magneto-optical disk, is provided and coupled to bus 302 for storing information and instructions.

Computer system 300 may be coupled via bus 302 to a display 312, such as a cathode ray tube (CRT) or a liquid crystal display (LCD), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical, magnetic, or magneto-optical disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. For example, the implementation of delta encoding described herein is applicable across multiple resources of similar type, not just to different versions of the same resource. Hence, a single canonical reference can be used to represent a portion of, for example, web pages identified by www.cnn.com, www.cnn.com/finance, www.cnn.com/business, ww.cnn.com/sports, etc. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method for distributing content, the method comprising:
generating a canonical reference file representing at least a portion of the content;
during a period in which the current state of the content differs from the canonical reference file, transmitting the canonical reference file to a client;
generating a delta file that represents a difference between the canonical reference file and the current state of the content; and
transmitting the delta file to the client to allow the client to construct the current state of the content based on the delta file and the canonical reference file.

2. The method of claim 1 wherein:
the step of transmitting the canonical reference file to a client is performed prior to the client requesting the content; and
the step of transmitting the delta file to the client is performed in response to the client requesting the content.

3. The method of claim 1 wherein both the canonical reference file and the delta file are transmitted to the client in response to a single request for the content from the client.

4. The method of claim 1, further comprising, prior to the step of transmitting the delta file, the step of:
retrieving the current state of the content from a cache of content previously retrieved from another server.

5. The method of claim 1 wherein the content includes static content and dynamic content, and
wherein the step of generating the canonical reference file generates the reference file based on the static content; and
wherein the step of generating the delta file generates the delta file based on the dynamic content.

6. The method of claim 1, further comprising, prior to the step of transmitting the delta file, the step of:
compressing the delta file.

7. The method of claim 6 wherein the steps of compressing and transmitting the delta file uses streaming technology that allows the content to be displayed as it is received without having to wait for the entire content to be received.

8. The method of claim 1, comprising the step of:
deleting the canonical reference file from a server that generated the canonical reference file and from one or more clients to which the server distributes the content, upon the canonical reference file not being referenced by the server or by the one or more clients for a particular period of time.

9. The method of claim 1, wherein the canonical reference file is common to a plurality of servers and to each of one or more clients to which each of the plurality of servers distributes the content, and wherein the step of transmitting the canonical reference file transmits the canonical reference file to one or more clients to which each of the plurality of servers distributes the file content.

10. The method of claim 9 wherein the step of generating the canonical reference file comprises the step of:
coalescing reference files from the plurality of servers.

11. The method of claim 9, comprising the step of:
transmitting, by a first server, the canonical reference file to one or more of the plurality of servers other than the first server.

12. The method of claim 1, comprising the steps of:
regenerating the canonical reference file in response to a condition upon which regenerating depends.

13. The method of claim 12 wherein the condition is expiration of a period of time since the last generation of the canonical reference file for the content, and
wherein the step of regenerating the canonical reference file is performed in response to the condition.

14. The method of claim 12 wherein the condition is receipt of a manually initiated command requesting regeneration of the canonical reference file for the content, and
wherein the step of regenerating the canonical reference file is performed in response to the condition.

15. The method of claim 12 wherein the condition is detection that the size of the delta file associated with the current state of the content meets or exceeds a size threshold,
wherein the step of regenerating the canonical reference file is performed in response to the condition.

16. The method of claim 12 wherein the condition is detection that the number of requests for the content meets or exceeds a request threshold, and
wherein the step of regenerating the canonical reference file is performed in response to the condition.

17. The method of claim 1, comprising the steps of:
applying a condition upon which the step of transmitting the canonical reference file depends, and wherein the step of transmitting the canonical reference file is based on the condition.

18. The method of claim 1 comprising the step of:
storing the delta file for transmission to an other client in response to the other client requesting the content.

19. A method for distributing content, the method comprising:
generating a canonical reference file representing at least a portion of the content;
transmitting the canonical reference file to a plurality of clients, including the steps of
transmitting the canonical reference file to a first client when the content is in a first state;
transmitting the canonical reference file to a second client when the content is in a second state that is different from the first state;
when any client of the plurality of clients requests the content, transmitting to the client a delta file that represents a difference between the canonical reference file and a current state of the content.

20. The method of claim 19 wherein:
the step of transmitting the canonical reference file to at least one of the first and second clients is performed prior to the respective first or second client requesting the content; and
the step of transmitting the delta file to the respective first or second client is performed in response to the respective first or second client requesting the content.

21. The method of claim 19 wherein both the canonical reference file and the delta file are transmitted to at least one of the first and second clients in response to a single request for the content from the respective first or second client.

22. The method of claim 19, further comprising, prior to the step of transmitting the delta file, the step of:
retrieving the current state of the content from a cache of content previously retrieved from another server.

23. The method of claim 19 wherein the content includes static content and dynamic content, and
wherein the step of generating the canonical reference file generates the reference file based on the static content; and
wherein a step of generating the delta file generates the delta file based on the dynamic content.

24. A method for receiving content, the method comprising:
receiving a canonical reference file representing at least a portion of the content, during a period of time in which the current state of the content differs from the canonical reference file;
receiving a delta file that represents a difference between the canonical reference file and the current state of the content; and
constructing the current state of the content based on the delta file and the canonical reference file.

25. The method of claim 24 wherein the canonical reference file is common to a plurality of clients and wherein the step of receiving the canonical reference file is performed by more than one of the plurality of clients.

26. The method of claim 24 wherein:
the step of receiving the canonical reference file is performed prior to requesting the content; and
the step of receiving the delta file is performed in response to a request for the content.

27. The method of claim 24 wherein both the canonical reference file and the delta file are received in response to a single request for the content.

28. The method of claim 24 comprising:
decompressing the delta file.

29. A system for implementing delta encoding for distribution of content, comprising:
at least one server, configured to
generate a canonical reference file representing at least a portion of the content;
during a period in which the current state of the content differs from the canonical reference file, transmit the canonical reference file to a client computer;
generate a delta file that represents a difference between the canonical reference file and the current state of the content; and
transmit the delta file to the client computer; and
a client program, configured on the client computer to
receive the canonical reference file;
receive the delta file; and
construct the current state of the content based on the delta file and the canonical reference file.

30. The system of claim 29, wherein the client program is installed on the at least one client computer prior to receiving the canonical reference file.

31. The system of claim 29 comprising:
a plurality of servers, wherein the plurality of servers are configured to store the canonical reference file.

32. The system of claim 31 wherein the client program is configurable to request communication with a particular server of the plurality of servers.

33. The system of claim 29, comprising:
a cache server, configured to store content retrieved through a network from another server;
wherein the at least one server retrieves the current state of the content from the cache server.

34. A computer-readable medium carrying one or more sequences of instructions for distributing content, wherein execution of the one or more sequences of instructions by one or more processors causes the one or more processors to perform the steps of:
generating a canonical reference file representing at least a portion of the content;
during a period in which the current state of the content differs from the canonical reference file, transmitting the canonical reference file to a client;
generating a delta file that represents a difference between the canonical reference file and the current state of the content; and
transmitting the delta file to the client to allow the client to construct the current state of the content based on the delta file and the canonical reference file.

35. A computer-readable medium carrying one or more sequences of instructions for distributing content, wherein execution of the one or more sequences of instructions by one or more processors causes the one or more processors to perform the steps of:
generating a canonical reference file representing at least a portion of the content;
transmitting the canonical reference file to a plurality of clients, including the steps of
transmitting the canonical reference file to a first client when the content is in a first state;
transmitting the canonical reference file to a second client when the content is in a second state that is different from the first state;
when any client of the plurality of clients requests the content, transmitting to the client a delta file that represents a difference between the canonical reference file and a current state of the content.

36. A computer-readable medium carrying one or more sequences of instructions for receiving content, wherein execution of the one or more sequences of instructions by one or more processors causes the one or more processors to perform the steps of:
receiving a canonical reference file representing at least a portion of the content, during a period of time in which the current state of the content differs from the canonical reference file;
receiving a delta file that represents a difference between the canonical reference file and the current state of the content; and
constructing the current state of the content based on the delta file and the canonical reference file.

37. A computer apparatus comprising:
a memory;
a network interface; and
one or more processors coupled to the memory and the network interface and configured to execute one or more sequence of instructions for distributing content, wherein execution of the one or more sequences of instructions by one or more processors causes the one or more processors to perform the steps of:
generating a canonical reference file representing at least a portion of the content;
during a period in which the current state of the content differs from the canonical reference file, transmitting the canonical reference file to a client;
generating a delta file that represents a difference between the canonical reference file and the current state of the content; and
transmitting the delta file to the client to allow the client to construct the current state of the content based on the delta file and the canonical reference file.

38. A computer apparatus comprising:
a memory;
a network interface; and
one or more processors coupled to the memory and the network interface and configured to execute one or more sequence of instructions for distributing content, wherein execution of the one or more sequences of instructions by one or more processors causes the one or more processors to perform the steps of:
generating a canonical reference file representing at least a portion of the content;
transmitting the canonical reference file to a plurality of clients, including the steps of
transmitting the canonical reference file to a first client when the content is in a first state;
transmitting the canonical reference file to a second client when the content is in a second state that is different from the first state;
when any client of the plurality of clients requests the content, transmitting to the client a delta file that represents a difference between the canonical reference file and a current state of the content.

39. A computer apparatus comprising:
a memory;
a network interface; and
one or more processors coupled to the memory and the network interface and configured to execute one or more sequence of instructions for receiving content, wherein execution of the one or more sequences of instructions by one or more processors causes the one or more processors to perform the steps of:
receiving a canonical reference file representing at least a portion of the content, during a period of time in which the current state of the content differs from the canonical reference file;
receiving a delta file that represents a difference between the canonical reference file and the current state of the content; and
constructing the current state of the content based on the delta file and the canonical reference file.
